(19) United States
(12) Patent Application Publication
(10) Pub. No.: US 2007/0093390 A1
(43) Pub. Date: Apr. 26, 2007

(54) Synergistically acting herbicidal mixtures

(75) Inventors: Matthias Witschel, Bad Durkheim (DE); Cyrill Zagar, Mannheim (DE); Andreas Landes, Romeberg-Heiligenstein (DE); Peter Dombo, Wiesbaden (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 10/548,733

(22) PCT Filed: Mar. 10, 2004
(86) PCT No.: PCT/EP04/02435

§ 371 Date: Sep. 13, 2005

Related U.S. Application Data
(60) Provisional application No. 60/453,957, filed on Mar. 13, 2003.

(51) Int. Cl. A01N 43/60

(52) U.S. Cl. 504/136

(57) ABSTRACT

A synergistic herbicidal mixture comprising A) [N-(5,7-Dimethoxy(1,2,4)triazolo[1,5-a]pyrimidin-2-yl)-2-methoxy-4-(trifluoro methyl)]-3-pyridinesulfonamide (I) or one of its environmentally compatible salts; B) at least a synergistically effective amount of a herbicidal compound from the group of the p-hydroxyphenylpyruvatdioxygenase (HPPD)-inhibitors; and, if desired, C) at least a safener selected from the group of dichlormid, benoxacor, LAB 145, 138, MG-191, furilazole, cyometrinil, oxabetrinil, fluoxfenim, flurazole, naphtalic acid anhydride, fenclorim, fenchlorazole, mefenpyr, isoxadifen, cloquintocet, 1-ethyl-4-hydroxy-3-(1H-tetrazol-5-yl)-1H-quinolin-2-one, 4-carboxy methyl-chroman-4carboxylic acid, N-(2-methoxy-benzoyl)-4-(3-methylureido)benzenesulfonamide, (3-oxo-isothiochroman-4ylidenemethoxy)-acetic acid methyl ester; or their environmentally compatible salts, amides, esters and hydrates. Compositions comprising these mixtures, processes for the preparation of these compositions and their use for controlling undesired plants.

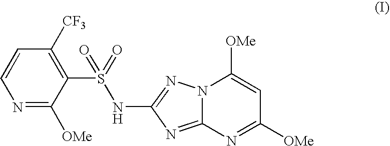

The present invention relates to a synergistic herbicidal mixture comprising
A) [N-(5,7-Dimethoxy(1,2,4)triazolo[1,5-a]pyrimidin-2-yl)-2-methoxy-4-(trifluoro-methyl)]-3-pyridinesulfonamide (I) 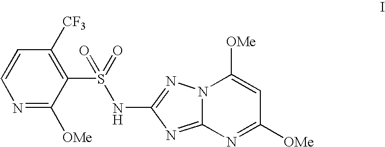
   or one of its environmentally compatible salts;
B) at least a synergistically effective amount of a herbicidal compound from the group of the p-hydroxyphenylpyruvat-dioxygenase(HPPD)-inhibitors;
   and, if desired,
C) at least a safener selected from the group of dichlormid, benoxacor, LAB 145 138, MG-191, furilazole, cyometrinil, oxabetrinil, fluxofenim, flurazole, naphtalic acid anhydride, fenclorim, fenchlorazole, mefenpyr, isoxadifen, cloquintocet, 1-ethyl-4-hydroxy-3-(1H-tetrazol-5-yl)-1H-quinolin-2-one, 4-carboxymethyl-chroman-4-carboxylic acid, N-(2-methoxy-benzoyl)-4-(3-methylureido)-benzenesulfonamide, (3-oxo-isothiochroman-4-ylidenemethoxy)-acetic acid methyl ester;
or their environmentally compatible salts, amides, esters and hydrates.

The invention furthermore relates to herbicidal compositions comprising a herbicidally active amount of a synergistic herbicidal mixture as defined above and at least one liquid and/or solid carrier and, if desired, at least one surfactant. Moreover, the invention relates to processes for the preparation of these compositions and to a method of controlling undesirable vegetation.

In crop protection products, it is always desirable to increase the specific activity of an active ingredient and the reliability of action. It is known from WO 02/36595 that mixtures of the compound of formula I with a further herbicide wherein the latter one is selective in cereals may be used in cereals against harmful plants. It is an object of the present invention to provide further mixtures which comprise a compound of formula I or its environmentally compatible salts which are selective in cereals and/or other crops to control undesirable harmful plants.

We have found that this object is achieved by the mixtures defined at the outset. We have furthermore found herbicidal compositions which comprise these mixtures, processes for their preparation, and methods of controlling undesirable vegetation. In the last-mentioned cases, it is irrelevant whether the herbicidally active compounds of the components A), B) and, if desired, C) are formulated and applied jointly or separately and in which sequence they are applied in the case of separate application.

The mixtures according to the invention show a synergistic effect.

Examples for the inhibitors of the p-hydroxyphenylpyruvat-dioxy-genase(HPPD) are pyrazolynate, pyrazoxyfen, benzofenap, sulcotrione, isoxaflutole, mesotrione, isoxachlortole, ketospiradox, 2-{2-chloro-3-[5-(cyanomethyl)-4,5-dihdroisoxazole-3-yl]-4-ethylsulfonylbenzoyl}-3-hydroxy-2-cyclohexen-1-one, 2-{2-chloro-4-(methylsulfonyl)-3-[(2,2,2-trifluoroethoxy)methyl]-benzoyl}-3-hydroxy-2-cyclohexen-1 -one, 4-Hydroxy-3-{[2-methyl-6-(trifluoromethyl)-3-pyridinyl]carbonyl}bicyclo-[3.2.1]oct-3-en-2-on, 4-Hydroxy-3-{2-[(2-methoxyethoxy)methyl]-6-(trifluoromethyl)-3-pyridinyl]carbonyl]-bicyclo[3.2.1]oct-3-en-2-one, 4-Hydroxy-3-[4-(methylsulfonyl)-2-nitrobenzoyl]bicyclo-[3.2.1]oct-3-en-2-one, 4-[2-chloro-3-(3-methyl-isoxazol-5-yl)-4-methylsulfonylbenzoyl]-1-methyl-5-hydroxy-1H-pyrazole, 4-[2-methyl-3-(3-methyl-isoxazol-5-yl)-4-methyl-sulfonylbenzoyl]-1-methyl-5-hydroxy-1H-pyrazole, 4-[2-chloro-3-(4,5-dihydroisoxazol-3-yl)-4-methylsulfonylbenzoyl]-1-methyl-5-hydroxy-1H-pyrazole and 4-[2-methyl-3-(4,5-dihydroisoxazol-3-yl)-4-methylsulfonylbenzoyl]-1-methyl-5-hydroxy-1H-pyrazole; or their environmentally compatible salts.

The compounds of the groups A), B) and, if desired, C) may also exist in the form of their environmentally compatible salts, esters, amides and hydrates.

Suitable salts, esters, amides and hydrates are, in general, those ones which do not adversly affect the herbicidal action or safening of the active ingredients.

Suitable cations are, in particular, ions of the alkali metals, preferably lithium, sodium and potassium, of the alkaline earth metals, preferably calcium and magnesium, and of the transition metals, preferably manganese, copper, zinc and iron, and also ammonium, it being possible in this case, if desired, for one to four hydrogen atoms to be replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, isopropylammonium, dimethylammonium, diisopropylammonium, tetramethylammonium, tetrabutylammonium, 2-(2-hydroxyeth-1-oxy)eth-1-yl ammonium, di(2-hydroxyeth-1-yl)ammonium, trimethylbenzylammonium, furthermore phosphonium ions, sulfonium ions, preferably tri(C₁-C₄-alkyl)-sufonium and sulfoxonium ions, preferably, tri(C₁-C₄-alkyl)-sulfoxonium.

Anions of suitable acid addition salts are mainly chloride, bromide, fluoride, hydrogen sulfate, sulfate, dihydrogen phosphate, hydrogen phosphate, nitrate, hydrogen carbonate, carbonate, hexafluorosilicate, hexafluorophosphate, benzoate and the anions of C₁-C₄-alkanoic acids, preferably formate, acetate, propionate and butyrate.

Suitable esters are alkly-, alkoxyalkyl-, allyl-, propargyl- and oxetan-3-ylesters, preferably C₁-C₁₀-esters, for example methyl-, ethyl-, propyl-, isopropyl-, butyl-, isobutyl-, pentyl-, mexyl-(≡1 -methyl-hexyl) or isoctyl-(≡2-ethylhexyl) ester, C₁-C₄-alkoxyethyl-esters, for example methoxyethyl-, ethoxyethyl- or butoxyethyl-ester, allylesters, proparyglesters and oxetan-3-ylesters.

Suitable amides are “amide” itself, alkyl- and dialkyl-amides as well as anilides, preferably C₁-C₄-alkyl-amides, for example methyl- or ethyl-amide, di(C₁-C₄-alkyl)-amides, for example dimethyl- or diethyl amide, or anilides, preferably anilide itself or 2-chloroanilide.

The compounds of components A), B) and, if desired C) as well as their salts, esters, amides and hydrates also may exist in the form of their tautomers and/or in form of the pure enantiomere, and also as racemates or diastereomer mixtures.

Preferred synergistic mixtures according to the invention comprise as component B) at least a compound selected from the group sulcotrione, isoxaflutole, mesotrione, 2-{2-chloro-3-[5-(cyanomethyl)-4,5-dihydroisoxazole-3-yl]-4ethylsulfonylbenzoyl}-3-hydroxy-2-cyclohexen-1-one, 2-{2-chloro-4-(methylsulfonyl)-3-[(2,2,2-trifluoroethoxy)-methyl]-benzoyl}-3-hydroxy-2-cyclohexen-1-one, 4-Hydroxy-3-{2-[(2-methoxyethoxy)-methyl]-6-(trifluoromethyl)-3-pyridinyl]carbonyl]bicyclo[3.2.1]oct-3-en-2-one, 4-[2-chloro-3-(4,5-dihydroisoxazol-3-yl)-4-methylsulfonylbenzoyl]-1-methyl-5-hydroxy-1H-pyrazole and 4-[2-methyl-3-(4,5-dihydroisoxazol-3-yl)-4-methylsulfonylbenzoyl]-1-methyl-5-hydroxy-1H-pyrazole, or their environmentally compatible salts.
Especially preferred are synergistic mixtures which comprise as component B) at least a compound selected from the group mesotrione, 2-{2-chloro-3-[5-(cyanomethyl)-4,5-dihdroisoxazole-3-yl]-4-ethylsulfonylbenzoyl}-3-hydroxy-2-cyclohexen-1-one, 2-{2-chloro-4-(methylsulfonyl)-3-[(2,2,2-trifluoroethoxy)methyl]-benzoyl}-3-hydroxy-2-cyclohexen-1-one, 4-Hydroxy-3-{2-[(2-methoxyethoxy)-methyl]-6-(trifluoromethyl)-3-pyridinyl]carbonyl]bicyclo[3.2.1]oct-3-en-2-one, 4-[2-chloro-3-(4,5-dihydroisoxazol-3-yl)-4-methylsulfonylbenzoyl]-1-methyl-5-hydroxy-1H-pyrazole and 4-[2-methyl-3-(4,5-dihydroisoxazol-3-yl)-4-methylsulfonylbenzoyl]-1-methyl-5-hydroxy-1H-pyrazole, or their environmentally compatible salts.
   Particularly preferred are synergistic mixtures which comprise as component B) 4-[2-chloro-3-(4,5-dihydroisoxazol-3-yl)-4-methylsulfonylbenzoyl]-1-methyl-5-hydroxy-1H-pyrazole, or one of its environmentally compatible salts.
   Also particularly preferred are synergistic mixtures which comprise as component B) 4-[2-methyl-3-(4,5-dihydroisoxazol-3-yl)-4-methylsulfonylbenzoyl]-1-methyl-5-hydroxy-1H-pyrazole, or one of its environmentally compatible salts.

Also preferred are synergistic mixtures which comprise as component C) at least a safener selected from the group of dichlormid, benoxacor, LAB 145 138, MG-191, furilazole, naphtalic acid anhydride, fenclorim, fenchlorazole, mefenpyr, isoxadifen and cloquintocet, or their environmentally compatible salts, amides, esters and hydrates.
Especially preferred are synergistic mixtures which comprise as component C) at least a compound selected from the group fenclorim, fenchlorazole, mefenpyr, isoxadifen and cloquintocet, or their environmentally compatible salts, amides, esters and hydrates.
   Particularly preferred are synergistic mixtures which comprise as component C) at least a compound selected from the group mefenpyr, isoxadifen and cloquintocet, or their environmentally compatible salts, amides, esters and hydrates.
   Extraordinary preferred are synergistic mixtures which comprise as component C) mefenpyr, or its environmentally compatible salts, amides and esters; preferably mefenpyr “acid” or mefenpyr diethyl; especially mefenpyr diethyl.
   Extraordinary preferred are synergistic mixtures which comprise as component C) isoxadifen, or one of its environmentally compatible salts, amides and esters; preferably isoxadifen “acid” or isoxadifen ethyl; especially isoxadifen ethyl.
   Extraordinary preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Also preferred are synergistic mixtures which comprise beneath the component A) as component B) at least one compound selected from the group pyrazolynate, pyrazoxyfen, benzofenap, sulcotrione, isoxaflutole, mesotrione, isoxachlortole, ketospiradox, 2-{2-chloro-3-[5-(cyanomethyl)-4,5-dihydroisoxazole-3-yl]-4-ethylsulfonyl-benzoyl}-3-hydroxy-2-cyclohexen-1-one, 2-{2-chloro-4-(methylsulfonyl)-3-[(2,2,2-trifluoroethoxy)-methyl]-benzoyl}-3-hydroxy-2-cyclohexen-1-one, 4-Hydroxy-3-{[2-methyl-6-(trifluoromethyl)-3-pyridinyl]carbonyl}-bicyclo[3.2.1]oct-3-en-2-on, 4-hydroxy-3-{2-[(2-methoxyethoxy)methyl]-6-(trifluoromethyl)-3-pyridinyl]carbonyl]-bicyclo[3.2.1]oct-3-en-2-one, 4-hydroxy-3-[4-(methylsulfonyl)-2-nitrobenzoyl]bicyclo-[3.2.1]oct-3-en-2-one, 4-[2-chloro-3-(3-methyl-isoxazol-5-yl)-4-methylsulfonylbenzoyl]-1-methyl-5-hydroxy-1H-pyrazole, 4-[2-methyl-3-(3-methyl-isoxazol-5-yl)-4-methylsulfonylbenzoyl]-1-methyl-5-hydroxy-1H-pyrazole, 4-[2-chloro-3-(4,5-dihydroisoxazol-3-yl)-4-methylsulfonylbenzoyl]-1-methyl-5-hydroxy-1H-pyrazole and 4-[2-methyl-3-(4,5-dihydroisoxazol-3-yl)-4-methylsulfonylbenzoyl]-1 -methyl-5-hydroxy-1H-pyrazole, or their environmentally compatible salts; and, if desired,

as component C) at least one compound selected from the group dichlormid, benoxacor, LAB 145 138, MG-191, furilazole, naphtalic acid anhydride, fenclorim, fenchlorazole, mefenpyr, isoxadifen and cloquintocet, or their environmentally compatible salts, amides, esters and hydrates.
Especially preferred are synergistic mixtures which comprise beneath the component A)
   as component B) at least one compound selected from the group sulcotrione, isoxaflutole, mesotrione, 2-{2-chloro-3-[5-(cyanomethyl)-4,5-dihydroisoxazole-3-yl]-4-ethylsulfonylbenzoyl}-3-hydroxy-2-cyclohexen-1-one, 2-{2-chloro-4-(methylsulfonyl)-3-[(2,2,2-trifluoroethoxy)methyl]-benzoyl}-3-hydroxy-2-cyclohexen-1-one, 4-hydroxy-3-{2-[(2-methoxyethoxy)-methyl]-(trifluoromethyl)-3-pyridinyl]carbonyl]-bicyclo[3.2.1]oct-3-en-2-one, 4-[2-chloro-3-(4,5-dihydroisoxazol-3-yl)-4-methylsulfonylbenzoyl]-1-methyl-5-hydroxy-1H-pyrazole and 4-[2-methyl-3-(4,5-dihydroisoxazol-3-yl)-4-methylsulfonyl-benzoyl]-1-methyl-5-hydroxy-1H-pyrazole, or their environmentally compatible salts;
   and, if desired,
   as component C) at least one compound selected from fenclorim, fenchlorazole, mefenpyr, isoxadifen and cloquintocet, or their environmentally compatible salts, amides, esters and hydrates.
Particularly preferred are synergistic mixtures which comprise beneath the component A)
   as component B) at least one compound selected from the group mesotrione, 2-{2-chloro-3-[5-(cyanomethyl)-4,5-dihdroisoxazole-3-yl]-4-ethylsulfonylbenzoyl}-3-hydroxy-2-cyclohexen-1-one, 2-{2-chloro-4-(methylsulfonyl)-3-[(2,2,2-trifluoroethoxy)methyl]-benzoyl}-3-hydroxy-2-cyclohexen-1-one, 4-hydroxy-3-{2-[(2-methoxyethoxy)-methyl]-6(trifluoromethyl)-3-pyridinyl]carbonyl]bicyclo[3.2.1]oct-3-en-2-one, 4-[2-chloro-3-(4,5-dihydroisoxazol-3-yl)-4-methylsulfonylbenzoyl]-1-methyl-5-hydroxy-1H-pyrazole and 4-[2-methyl-3-(4,5dihydroisoxazol-3-yl)-4-methylsulfonylbenzoyl]-1-methyl-5-hydroxy-1H-pyrazole, or their environmentally compatible salts,
   and, if desired,
   as component C) at least one compound selected from mefenpyr, isoxadifen and cloquintocet, or their environmentally compatible salts, amides, esters and hydrates.
   Extraordinary preferred are synergistic mixtures which comprise beneath the component A)
   as component B) 4-[2-chloro-3-(4,5-dihydroisoxazol-3-yl)-4-methylsulfonylbenzoyl]-1-methyl-5-hydroxy-1H-pyrazole, or one of its environmentally compatible salts,
   and, if desired,
   as component C) cloquintocet, or one of its environmentally compatible esters and hydrates.
   Also extraordinary preferred are synergistic mixtures which comprise beneath the component A)
   as component B) 4-[2-methyl-3-(4,5-dihydroisoxazol-3-yl)-4-methylsulfonylbenzoyl]-1-methyl-5-hydroxy-1H-pyrazole, or one of its environmentally compatible salts,
   and, if desired,
   as component C) cloquintocet, or one of its environmentally compatible esters and hydrates.

Also preferred are synergistic mixtures which comprise beneath the component A) as component B) pyrazolynate, or their environmentally compatible salts.

Also preferred are synergistic mixtures which comprise beneath the component A) as component B) pyrazolynate, or their environmentally compatible salts, and as component C) at least a compound selected from the group mefenpyr, isoxadifen and cloquintocet, or their environmentally compatible salts, amides, esters and hydrates.
Especially preferred are synergistic mixtures which comprise as component C) mefenpyr, or their environmentally compatible salts, amides and esters; preferably mefenpyr “acid” or mefenpyr diethyl; especially mefenpyr diethyl.
Also especially preferred are synergistic mixtures which comprise as component C) isoxadifen, or one of its environmentally compatible salts, amides and esters; preferably isoxadifen “acid” or isoxadifen ethyl; especially isoxadifen ethyl.
Also especially preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Also preferred are synergistic mixtures which comprise beneath the component A) as component B) pyrazoxyfen, or their environmentally compatible salts.

Also preferred are synergistic mixtures which comprise beneath the component A) as component B) pyrazoxyfen, or their environmentally compatible salts, and as component C) at least a compound selected from the group mefenpyr, isoxadifen and cloquintocet, or their environmentally compatible salts, amides, esters and hydrates.
Especially preferred are synergistic mixtures which comprise as component C) mefenpyr, or one of its environmentally compatible salts, amides and esters; preferably mefenpyr “acid” or mefenpyr diethyl; especially mefenpyr diethyl.
Also especially preferred are synergistic mixtures which comprise as component C) isoxadifen, or one of its environmentally compatible salts, amides and esters; preferably isoxadifen “acid” or isoxadifen ethyl; especially isoxadifen ethyl.
Also especially preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Also preferred are synergistic mixtures which comprise beneath the component A) as component B) benzofenap, or their environmentally compatible salts.

Also preferred are synergistic mixtures which comprise beneath the component A) as component B) benzofenap, or their environmentally compatible salts, and as component C) at least a compound selected from the group mefenpyr, isoxadifen and cloquintocet, or their environmentally compatible salts, amides, esters and hydrates.
Especially preferred are synergistic mixtures which comprise as component C) mefenpyr, or one of its environmentally compatible salts, amides and esters; preferably mefenpyr “acid” or mefenpyr diethyl; especially mefenpyr diethyl.
Also especially preferred are synergistic mixtures which comprise as component C) isoxadifen, or one of its environmentally compatible salts, amides and esters; preferably isoxadifen “acid” or isoxadifen ethyl; especially isoxadifen ethyl.
Also especially preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Also preferred are synergistic mixtures which comprise beneath the component A) as component B) sulcotrione, or their environmentally compatible salts.

Also preferred are synergistic mixtures which comprise beneath the component A) as component B) sulcotrione, or their environmentally compatible salts, and as component C) at least a compound selected from the group mefenpyr, isoxadifen and cloquintocet, or their environmentally compatible salts, amides, esters and hydrates.
Especially preferred are synergistic mixtures which -comprise as component C) mefenpyr, or their environmentally compatible salts, amides and esters; preferably mefenpyr “acid” or mefenpyr diethyl; especially mefenpyr diethyl.
Also especially preferred are synergistic mixtures which comprise as component C) isoxadifen, or one of its environmentally compatible salts, amides and esters; preferably isoxadifen “acid” or isoxadifen ethyl; especially isoxadifen ethyl.
Also especially preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Also preferred are synergistic mixtures which comprise beneath the component A) as component B) isoxaflutole, or their environmentally compatible salts.

Also preferred are synergistic mixtures which comprise beneath the component A) as component B) isoxaflutole, or their environmentally compatible salts, and as component C) at least a compound selected from the group mefenpyr, isoxadifen and cloquintocet, or their environmentally compatible salts, amides, esters and hydrates.
Especially preferred are synergistic mixtures which comprise as component C) mefenpyr, or one of its environmentally compatible salts, amides and esters; preferably mefenpyr “acid” or mefenpyr diethyl; especially mefenpyr diethyl.
Also especially preferred are synergistic mixtures which comprise as component C) isoxadifen, or one of its environmentally compatible salts, amides and esters; preferably isoxadifen “acid” or isoxadifen ethyl; especially isoxadifen ethyl.
Also especially preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Also preferred are synergistic mixtures which comprise beneath the component A) as component B) mesotrione, or their environmentally compatible salts.

Also preferred are synergistic mixtures which comprise beneath the component A) as component B) mesotrione, or their environmentally compatible salts, and as component C) at least a compound selected from the group mefenpyr, isoxadifen and cloquintocet, or their environmentally compatible salts, amides, esters and hydrates.
Especially preferred are synergistic mixtures which comprise as component C) mefenpyr, or one of its environmentally compatible salts, amides and esters; preferably mefenpyr “acid” or mefenpyr diethyl; especially mefenpyr diethyl.
Also especially preferred are synergistic mixtures which comprise as component C) isoxadifen, or one of its environmentally compatible salts, amides and esters; preferably isoxadifen “acid” or isoxadifen ethyl; especially isoxadifen ethyl.
Also especially preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Also preferred are synergistic mixtures which comprise beneath the component A) as component B) isoxachlortole, or their environmentally compatible salts.

Also preferred are synergistic mixtures which comprise beneath the component A) as component B) isoxachlortole, or their environmentally compatible salts, and as component C) at least a compound selected from the group mefenpyr, isoxadifen and cloquintocet, or their environmentally compatible salts, amides, esters and hydrates.
Especially preferred are synergistic mixtures which comprise as component C) mefenpyr, or one of its environmentally compatible salts, amides and esters; preferably mefenpyr “acid” or mefenpyr diethyl; especially mefenpyr diethyl.
Also especially preferred are synergistic mixtures which comprise as component C) isoxadifen, or one of its environmentally compatible salts, amides and esters; preferably isoxadifen “acid” or isoxadifen ethyl; especially isoxadifen ethyl.
Also especially preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Also preferred are synergistic mixtures which comprise beneath the component A) as component B) ketospiradox, or their environmentally compatible salts.

Also preferred are synergistic mixtures which comprise beneath the component A) as component B) ketospiradox, or their environmentally compatible salts, and as component C) at least a compound selected from the group mefenpyr, isoxadifen and cloquintocet, or their environmentally compatible salts, amides, esters and hydrates.
Especially preferred are synergistic mixtures which comprise as component C) mefenpyr, or one of its environmentally compatible salts, amides and esters; preferably mefenpyr “acid” or mefenpyr diethyl; especially mefenpyr diethyl.
Also especially preferred are synergistic mixtures which comprise as component C) isoxadifen, or one of its environmentally compatible salts, amides and esters; preferably isoxadifen “acid” or isoxadifen ethyl; especially isoxadifen ethyl.
Also especially preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Also preferred are synergistic mixtures which comprise beneath the component A) as component B) 2-{2-chloro-3-[5-(cyanomethyl)-4,5-dihdroisoxazole-3-yl]-4-ethylsulfonylbenzoyl}-3-hydroxy-2-cyclohexen-1-one, or their environmentally compatible salts.

Also preferred are synergistic mixtures which comprise beneath the component A) as component B) 2-{2-chloro-3-[5-(cyanomethyl)-4,5-dihdroisoxazole-3-yl]-4-ethylsulfonylbenzoyl}-3-hydroxy-2-cyclohexen-1-one, or their environmentally compatible salts, and as component C) at least a compound selected from the group mefenpyr, isoxadifen and cloquintocet, or their environmentally compatible salts, amides, esters and hydrates.
Especially preferred are synergistic mixtures which comprise as component C) mefenpyr, or one of its environmentally compatible salts, amides and esters; preferably mefenpyr “acid” or mefenpyr diethyl; especially mefenpyr diethyl.
Also especially preferred are synergistic mixtures which comprise as component C) isoxadifen, or one of its environmentally compatible salts, amides and esters; preferably isoxadifen “acid” or isoxadifen ethyl; especially isoxadifen ethyl.
Also especially preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Also preferred are synergistic mixtures which comprise beneath the component A) as component B) 2-{2-chloro-4-(methylsulfonyl)-3-[(2,2,2-trifluoroethoxy)methyl]-benzoyl}-3-hydroxy-2-cyclohexen-1-one, or their environmentally compatible salts.

Also preferred are synergistic mixtures which comprise beneath the component A) as component B) 2-{2-chloro-4-(methylsulfonyl)-3-[(2,2,2-trifluoroethoxy)methyl]-benzoyl}-3-hydroxy-2-cyclohexen-1-one, or their environmentally compatible salts, and as component C) at least a compound selected from the group mefenpyr, isoxadifen and cloquintocet, or their environmentally compatible salts, amides, esters and hydrates.
Especially preferred are synergistic mixtures which comprise as component C) mefenpyr, or one of its environmentally compatible salts, amides and esters; preferably mefenpyr “acid” or mefenpyr diethyl; especially mefenpyr diethyl.
Also especially preferred are synergistic mixtures which comprise as component C) isoxadifen, or one of its environmentally compatible salts, amides and esters; preferably isoxadifen “acid” or isoxadifen ethyl; especially isoxadifen ethyl.
Also especially preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Also preferred are synergistic mixtures which comprise beneath the component A) as component B) 4-hydroxy-3-{[2-methyl-6-(trifluoromethyl)-3-pyridinyl]carbonyl}bicyclo-[3.2.1]oct-3-en-2-on, or their environmentally compatible salts.

Also preferred are synergistic mixtures which comprise beneath the component A) as component B) 4-hydroxy-3-{[2-methyl-6-(trifluoromethyl)-3-pyridinyl]carbonyl}bicyclo-[3.2.1]oct-3-en-2-on, or their environmentally compatible salts, and as component C) at least a compound selected from the group mefenpyr, isoxadifen and cloquintocet, or their environmentally compatible salts, amides, esters and hydrates.
Especially preferred are synergistic mixtures which comprise as component C) mefenpyr, or one of its environmentally compatible salts, amides and esters; preferably mefenpyr “acid” or mefenpyr diethyl; especially mefenpyr diethyl.
Also especially preferred are synergistic mixtures which comprise as component C) isoxadifen, or one of its environmentally compatible salts, amides and esters; preferably isoxadifen “acid” or isoxadifen ethyl; especially isoxadifen ethyl.
Also especially preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Also preferred are synergistic mixtures which comprise beneath the component A) as component B) 4-hydroxy-3-{2-[(2-methoxyethoxy)methyl]-6-(trifluoromethyl)-3-pyridinyl}-carbonylbicyclo[3.2.1]oct-3-en-2-one, or their environmentally compatible salts.

Also preferred are synergistic mixtures which comprise beneath the component A) as component B) 4-hydroxy-3-{2-[(2-methoxyethoxy)methyl]-6-(trifluoromethyl)-3-pyridinyl}carbonylbicyclo[3.2.1]oct-3-en-2-one, or their environmentally compatible salts, and as component C) at least a compound selected from the group mefenpyr, isoxadifen and cloquintocet, or their environmentally compatible salts, amides, esters and hydrates.
Especially preferred are synergistic mixtures which comprise as component C) mefenpyr, or one of its environmentally compatible salts, amides and esters; preferably mefenpyr “acid” or mefenpyr diethyl; especially mefenpyr diethyl.
Also especially preferred are synergistic mixtures which comprise as component C) isoxadifen, or one of its environmentally compatible salts, amides and esters; preferably isoxadifen “acid” or isoxadifen ethyl; especially isoxadifen ethyl.
Also especially preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Also preferred are synergistic mixtures which comprise beneath the component A) as component B) 4-hydroxy-3-[4-(methylsulfonyl)-2-nitrobenzoyl]bicyclo[3.2.1]oct-3-en-2-one, or their environmentally compatible salts.

Also preferred are synergistic mixtures which comprise beneath the component A) as component B) 4-hydroxy-3-[4-(methylsulfonyl)-2-nitrobenzoyl]bicyclo-[3.2.1]oct-3-en-2-one, or their environmentally compatible salts, and as component C) at least a compound selected from the group mefenpyr, isoxadifen and cloquintocet, or their environmentally compatible salts, amides, esters and hydrates.
Especially preferred are synergistic mixtures which comprise as component C) mefenpyr, or one of its environmentally compatible salts, amides and esters; preferably mefenpyr “acid” or mefenpyr diethyl; especially mefenpyr diethyl.
Also especially preferred are synergistic mixtures which comprise as component C) isoxadifen, or one of its environmentally compatible salts, amides and esters; preferably isoxadifen “acid” or isoxadifen ethyl; especially isoxadifen ethyl.
Also especially preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Also preferred are synergistic mixtures which comprise beneath the component A) as component B) 4-[2-chloro-3-(3methyl-isoxazol-5-yl)-4-methylsulfonylbenzoyl]-1-methyl-5-hydroxy-1H-pyrazole, or their environmentally compatible salts.

Also preferred are synergistic mixtures which comprise beneath the component A) as component B) 4-[2-chloro-3-(3-methyl-isoxazol-5-yl)-4-methylsulfonylbenzoyl]-1-methyl-5-hydroxy-1H-pyrazole, or their environmentally compatible salts, and as component C) at least a compound selected from the group mefenpyr, isoxadifen and cloquintocet, or their environmentally compatible salts, amides, esters and hydrates.
Especially preferred are synergistic mixtures which comprise as component C) mefenpyr, or one of its environmentally compatible salts, amides and esters; preferably mefenpyr “acid” or mefenpyr diethyl; especially mefenpyr diethyl.
Also especially preferred are synergistic mixtures which comprise as component C) isoxadifen, or one of its environmentally compatible salts, amides and esters; preferably isoxadifen “acid” or isoxadifen ethyl; especially isoxadifen ethyl.
Also especially preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Also preferred are synergistic mixtures which comprise beneath the component A) as component B) 4-[2-methyl-3-(3-methyl-isoxazol-5-yl)-4-methylsulfonylbenzoyl]-1-methyl-5-hydroxy-1H-pyrazole, or their environmentally compatible salts.

Also preferred are synergistic mixtures which comprise beneath the component A) as component B) 4-[2-methyl-3-(3-methyl-isoxazol-5-yl)4-methylsulfonylbenzoyl]-1-methyl-5-hydroxy-1H-pyrazole, or their environmentally compatible salts, and as component C) at least a compound selected from the group mefenpyr, isoxadifen and cloquintocet, or their environmentally compatible salts, amides, esters and hydrates.
Especially preferred are synergistic mixtures which comprise as component C) mefenpyr, or one of its environmentally compatible salts, amides and esters; preferably mefenpyr “acid” or mefenpyr diethyl; especially mefenpyr diethyl.
Also especially preferred are synergistic mixtures which comprise as component C) isoxadifen, or one of its environmentally compatible salts, amides and esters; preferably isoxadifen “acid” or isoxadifen ethyl; especially isoxadifen ethyl.
Also especially preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Also preferred are synergistic mixtures which comprise beneath the component A) as component B) 4-[2-chloro-3-(4,5-dihydroisoxazol-3-yl)-4-methylsulfonylbenzoyl]-1-methyl-5-hydroxy-1H-pyrazole, or their environmentally compatible salts.

Also preferred are synergistic mixtures which comprise beneath the component A) as component B) 4-[2-chloro-3-(4,5-dihydroisoxazol-3-yl)-4-methylsulfonylbenzoyl]-1-methyl-5-hydroxy-1H-pyrazole, or their environmentally compatible salts, and as component C) at least a compound selected from the group mefenpyr, isoxadifen and cloquintocet, or their environmentally compatible salts, amides, esters and hydrates.
Especially preferred are synergistic mixtures which comprise as component C) mefenpyr, or one of its environmentally compatible salts, amides and esters; preferably mefenpyr “acid” or mefenpyr diethyl; especially mefenpyr diethyl.
Also especially preferred are synergistic mixtures which comprise as component C) isoxadifen, or one of its environmentally compatible salts, amides and esters; preferably isoxadifen “acid” or isoxadifen ethyl; especially isoxadifen ethyl.
Also especially preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Also preferred are synergistic mixtures which comprise beneath the component A) as component B) 4-[2-methyl-3-(4,5-dihydroisoxazol-3-yl)-4-methylsulfonylbenzoyl]-1-methyl-5-hydroxy-1H-pyrazole, or their environmentally compatible salts.

Also preferred are synergistic mixtures which comprise beneath the component A) as component B) 4-[2-methyl-3-(4,5-dihydroisoxazol-3-yl)-4-methylsulfonylbenzoyl]-1-methyl-5-hydroxy-1H-pyrazole, or their environmentally compatible salts, and as component C) at least a compound selected from the group mefenpyr, isoxadifen and cloquintocet, or their environmentally compatible salts, amides, esters and hydrates.
Especially preferred are synergistic mixtures which comprise as component C) mefenpyr, or one of its environmentally compatible salts, amides and esters; preferably mefenpyr “acid” or mefenpyr diethyl; especially mefenpyr diethyl.
Also especially preferred are synergistic mixtures which comprise as component C) isoxadifen, or one of its environmentally compatible salts, amides and esters; preferably isoxadifen “acid” or isoxadifen ethyl; especially isoxadifen ethyl.
Also especially preferred are synergistic mixtures which comprise as component C) cloquintocet, or one of its environmentally compatible salts, amides, esters and hydrates; preferably cloquintocet “acid”, cloquintocet mexyl or cloquintocet mexyl x n hydrate (n=2 to 6); especially cloquintocet mexyl.

Moreover it may be advantageous that the synergistic mixture according to the present invention comprises as active ingredients a compound of formula I, or one of its environmentally compatible salts, at least a compound of group B), if desired at least a compound of group C), and furthermore at least a herbicide of group D).

Examples of suitable herbicides of group D) are, inter alia, acetyl-CoA carboxylase inhibitors (ACC), acetolactate synthase inhibitors (ALS), amides, auxin herbicides, auxin transport inhibitors, carotenoid biosynthesis inhibitors, enolpyruvylshikimate 3-phosphate synthase inhibitors (EPSPS), glutamine synthetase inhibitors, lipid biosynthesis inhibitors, mitosis inhibitors, protoporphyrinogen IX oxidase inhibitors, photosynthesis inhibitors, synergists, growth substances, cell wall biosynthesis inhibitors and a variety of other herbicides.

Special examples of herbicides of group D) which can be used, are inter alia,

D1 acetyl-CoA carboxylase inhibitors (ACC), for example
cyclohexenone oxime ethers, such as alloxydim, clethodim, cloproxydim, cycloxydim, sethoxydim, tralkoxydim, butroxydim, clefoxydim or tepraloxydim;
phenoxyphenoxypropionic esters, such as clodinafop-propargyl, cyhalofopbutyl, diclofop-methyl, fenoxaprop-ethyl, fenoxaprop-P-ethyl, fenthiapropethyl, fluazifop-butyl, fluazifop-P-butyl, haloxyfop-ethoxyethyl, haloxyfop-methyl, haloxyfop-P-methyl, isoxapyrifop, propaquizafop, quizalofop-ethyl, quizalofop-P-ethyl or quizalofop-tefuryl; or
arylaminopropionic acids, such as flamprop-methyl or flamprop-isopropyl;

D2 acetolactate synthase inhibitors (ALS), for example
imidazolinones, such as imazapyr, imazaquin, imazamethabenz-methyl (imazame), imazamox, imazapic or imazethapyr;
pyrimidyl ethers, such as pyrithiobac-acid, pyrithiobac-sodium, bispyribac-sodium, KIH-6127 or pyribenzoxym;
sulfonamides, such as cloransulam, diclosulam, florasulam, flumetsulam, metosulam or penoxsulam; or
sulfonylureas, such as amidosulfuron, azimsulfuron, bensulfuron-methyl, chlorimuronethyl, chlorsulfuron, cinosulfuron, cyclosulfamuron, ethametsulfuron-methyl, ethoxysulfuron, flazasulfuron, foramsulfuron, halosulfuron-methyl, imazosulfuron, iodosulfuron, metsulfuron-methyl, nicosulfuron, primisulfuron-methyl, prosulfuron, pyrazosulfuronethyl, rimsulfuron, sulfometuron-methyl or -3-oxetanyl, sulfosulfuron, thifensulfuron-methyl, triasulfuron, tribenuron-methyl, triflusulfuron-methyl or tritosulfuron;

D3 amides, for example
allidochlor (CDM), benzoylprop-ethyl, bromobutide, chlorthiamid, diphenamid, etobenzanid (benzchlomet), fluthiamide, fosamin or monalide;

D4 auxin herbicides, for example
pyridinecarboxylic acids, such as clopyralid or picloram; or
2,4-D or benazolin;

D5 auxin transport inhibitors, for example
naptalame or diflufenzopyr;

D6 carotenoid biosynthesis inhibitors, for example
amitrol, clomazone (dimethazone), diflufenican, fluorochloridone, fluridone, flurtamone, norflurazon or picolinafen;

D7 enolpyruvylshikimate-3-phosphate synthase inhibitors (EPSPS), for example
glyphosate or sulfosate;

D8 glutamine synthetase inhibitors, for example
bilanafos (bialaphos) or glufosinate-ammonium;

D9 lipid biosynthesis inhibitors, for example
anilides, such as anilofos or mefenacet;
chloroacetanilides, such as dimethenamid, S-dimethenamid, acetochlor, alachlor, butachlor, butenachlor, diethatyl-ethyl, dimethachlor, metazachlor, metolachlor, S-metolachlor, pretilachlor, propachlor, prynachlor, terbuchlor, thenylchlor or xylachlor;
thioureas, such as butylate, cycloate, di-allate, dimepiperate, EPTC, esprocarb, molinate, pebulate, prosulfocarb, thiobencarb (benthiocarb), tri-allate or vernolate; or
benfuresate or perfluidone;

D10 mitosis inhibitors, for example
carbamates, such as asulam, carbetamid, chlorpropham, orbencarb, pronamid (propyzamid), propham or tiocarbazil;
dinitroanilines, such as benefin, butralin, dinitramin, ethalfluralin, fluchloralin, oryzalin, pendimethalin, prodiamine or trifluralin;
pyridines, such as dithiopyr or thiazopyr; or
butamifos, chlorthal-dimethyl (DCPA) or maleic hydrazide;

D11 protoporphyrinogen IX oxidase inhibitors, for example
diphenyl ethers, such as acifluorfen, acifluorfen-sodium, aclonifen, bifenox, chlornitrofen (CNP), ethoxyfen, fluorodifen, fluoroglycofen-ethyl, fomesafen, furyloxyfen, lactofen, nitrofen, nitrofluorfen or oxyfluorfen;
oxadiazoles, such as oxadiargyl or oxadiazon;
cyclic imides, such as azafenidin, butafenacil, carfentrazone-ethyl, cinidon-ethyl, flumiclorac-pentyl, flumioxazin, flumipropyn, flupropacil, fluthiacet-methyl, sulfentrazone or thidiazimin; or
pyrazoles, such as ET-751, JV 485 or nipyraclofen;

D12 photosynthesis inhibitors, for example
propanil, pyridate or pyridafol;
benzothiadiazinones, such as bentazone;
dinitrophenols, for example bromofenoxim, dinoseb, dinoseb-acetate, dinoterb or DNOC;
dipyridylenes, such as cyperquat-chloride, difenzoquat-methylsulfate, diquat or paraquat-dichloride;
ureas, such as chlorbromuron, chlorotoluron, difenoxuron, dimefuron, diuron, ethidimuron, fenuron, fluometuron, isoproturon, isouron, linuron, methabenzthiazuron, methazole, metobenzuron, metoxuron, monolinuron, neburon, siduron or tebuthiuron;
phenols, such as bromoxynil or ioxynil;
chloridazon;
triazines, such as ametryn, atrazine, cyanazine, desmetryn, dimethamethryn, hexazinone, prometon, prometryn, propazine, simazine, simetryn, terbumeton, terbutryn, terbutylazine or trietazine;
triazinones, such as metamitron or metribuzin;
uracils, such as bromacil, lenacil or terbacil; or
biscarbamates, such as desmedipham or phenmedipham;

D13 synergists, for example
oxiranes, such as tridiphane;

D14 growth substances, for example
aryloxyalkanoic acids, such as 2,4-DB, clomeprop, dichlorprop, dichlorprop-P (2,4-DP-P), fluoroxypyr, MCPA, MCPB, mecoprop, mecoprop-P or triclopyr;
benzoic acids, such as chloramben or dicamba; or
quinolinecarboxylic acids, such as quinclorac or quinmerac;

D15 cell wall synthesis inhibitors, for example
isoxaben or dichlobenil;

D16 various other herbicides, for example
dichloropropionic acids, such as dalapon;
dihydrobenzofurans, such as ethofumesate;
phenylacetic acids, such as chlorfenac (fenac); or
aziprotryn, barban, bensulide, benzthiazuron, benzofluor, buminafos, buthidazole, buturon, cafenstrole, chlorbufam, chlorfenprop-methyl, chloroxuron, cinmethylin, cumyluron, cycluron, cyprazine, cyprazole, dibenzyluron, dipropetryn, dymron, eglinazin-ethyl, endothall, ethiozin, flucabazone, fluorbentranil, flupoxam, isocarbamid, isopropalin, karbutilate, mefluidide, monuron, napropamide, napropanilide, nitralin, oxaciclomefone, phenisopham, piperophos, procyazine, profluralin, pyributicarb, secbumeton, sulfallate (CDEC), terbucarb, triaziflam, triazofenamid or trimeturon;
   or their environmentally compatible salts, “acids”, esters and amides.

The assignment of the active ingredients to the respective mechanisms of action is based on current knowledge. If several mechanisms of action apply to one active ingredient, this substance was only assigned to one mode of action.

Suitable salts, esters and amides are similar to those mentioned for the compounds of groups A), B) and C).

The compounds of group D) as well as their salts, “acids”, esters and amides, may also exist in the form of the pure enantiomere, and also as racemates or diastereomer mixtures.

Preferred are synergistic mixtures which comprise as active ingredients beneath the compound of formula I, or one of its environmentally salts, only one compound of group B).

Especially preferred synergistic mixtures thereof are in analogy to the above-mentioned ones.

Preferred are synergistic mixtures which comprise as active ingredients beneath the compound of formula I, or one of its environmentally salts, only one compound of group B) and one compound of group C).

Especially preferred synergistic mixtures thereof are in analogy to the above-mentioned ones.

The compound of the formula I is disclosed in WO 02/36595.

The inhibitors of the p-hydroxyphenylpyruvat-dioxygenase(HPPD) are described, for example, inter alia in
“Herbizide [Herbicides]”, Hock, Fedtke, Schmidt, 1^{st} edition, Thieme 1995 (“pyrazolynate” p. 146, “pyrazoxyfen” p. 146);
“Agricultural Chemicals”, Book II Herbicides, 1993 (“benzofenap” p. 221, “sulcotrione (ICIA-0051)” p. 268);
“Agricultural Chemicals”, Book II Herbicides, 13^{th} Edition (“isoxaflutole” p. 283);
Pest Management Science (2002), 58(9) 981-984 (“mesotrione”);
EP 470 856 (“isoxachlortole”);
WO 97/1550 (“ketospiradox”);
WO 2001/097614 (“2-{2-chloro-3-[5-(cyanomethyl)-4,5-dihdroisoxazole-3-yl]-4-ethylsulfonyl-benzoyl}-3-hydroxy-2-cyclohexen-1-one”);
WO 2000/021924 (“2-{2-chloro-4-(methylsulfonyl)-3-[(2,2,2-trifluoroethoxy)-methyl]benzoyl}-3-hydroxy-2-cyclohexen-1-one”);
WO 2001/094339 (“4-Hydroxy-3-{[2-methyl-6-(trifluoromethyl)-3-pyridinyl]-carbonyl}bicyclo[3.2.1]oct-3-en-2-one”);
WO 2001/054501 (“4-Hydroxy-3-{2-[(2-methoxyethoxy)methyl]-6-(trifluoromethyl)-3-pyridinyl]carbonyl}bicyclo[3.2.1]oct-3-en-2-one”);
EP 338 992 (“4-Hydroxy-3-[4-(methylsulfonyl)-2-nitrobenzoyl]-bicyclo[3.2.1]oct-3-en-2-on”);
WO 97/41116 (“4-[2-chloro-3-(3-methyl-isoxazol-5-yl)-4-methylsulfonylbenzoyl]-1-methyl-5-hydroxy-1H-pyrazole”);
WO 97/41118 (“4-[2-methyl-3-(3-methyl-isoxazol-5-yl)-4-methylsuffonylbenzoyl]-1-methyl-5-hydroxy-1H-pyrazole”);
WO 98/31681 (“4-[2-chloro-3-(4,5-dihydroisoxazol-3-yl)-4-methylsulfonyl-benzoyl]-1-methyl-5-hydroxy-1H-pyrazole” and “4-[2-methyl-3-(4,5-dihydroisoxazol-3-yl)-4-methylsulfonylbenzoyl]-1-methyl-5-hydroxy-1H-pyrazole”).

The above mentioned safeners (component C) are described, for example, in
“Herbizide [Herbicides]”, Hock, Fedtke, Schmidt, 1^{st} edition, Thieme 1995 (“di-chlormid” p. 263, “benoxacor” p. 263, “LAB 145 138” p. 263, “MG-191” p. 263, “MON-13900” p. 263, “cyometrinil” p. 265, “oxabetrinil” p. 265, “fluxofenim” p. 265, “flurazole” p. 265, “naphtalic acid anhydride” p. 265, “fenchlorim” p. 266, “fenchlorazol” p. 266, “cloquintocet” p. 266);
WO 91/07874 (“mefenpyr”);
WO 99/00020 (“1-ethyl-4-hydroxy-3-(1H-tetrazol-5-yl)-1H-quinolin-2-one”);
EP 613 618 (“4-carboxymethyl-chroman-4-carboxylic acid”);
U.S. Pat. No. 5,215,570 (“N-(2-methoxy-benzoyl)-4-(3-methylureido)-benzenesulfonamide”);
EP 929 543 (“3-oxo-isothiochroman-4-ylidenemethoxy)-acetic acid methyl ester”).

The herbicidally active compounds from amongst groups D1 to D16 are described, for example, in
“Herbizide [Herbicides]”, Hock, Fedtke, Schmidt, 1st edition, Thieme 1995 (s. “azimsulfuron (DPX-A-8947)” p. 175, “bensulfuron” p. 31, “pyrazosulfuron” p. 31, “cinosulfuron” p. 31, “ethametsulfuron” p. 36, “thifensulfuron” p. 35; “quinclorac” p. 238, “molinat” p. 32, “butachlor” p. 32, “pretilachlor” p. 32, “dithiopyr” p. 32, “mefenacet” p. 32, “fenoxapropethyl” p. 216, “dimepiperate” p. 32, “pyrazolynate” p. 146, “pyrazoxyfen” p. 146, “benfuresate” p. 233, “bromobutide” p. 243, “dymron” p. 243, “dimethyametryn” p. 118, “esprocarb” p. 229, “pyributicarb” p. 32, “cinemthylin” p. 32, “propanil” p. 32, “2,4-D” p. 30, “bentazon”p. 30, “mecoprop-P” p. 237, “chlorpropham” p. 205, “ethoxyfen” p. 30, “haloxyfop-P-methyl” p. 38, “haloxyfop-ethoxyethyl” p. 38, “flumiclorac-pentyl” p. 35, “flupropacil” p. 143, “nipyraclofen” p. 145, “pyrithiobac acid” p. 181);
“Agricultural Chemicals”, Book II Herbicides, 1993 (s. “imazosulfuron (TH-913)” p. 150, halosulfuron” p. 148, “rimsulfuron” p. 138, “tribenuron” p. 139, “triflusulfuron” p. 137, “primisulfuron” p. 147, “thiobencarb” p. 85, “benzofenap” p. 221, “napropanilid” p. 49, “piperophos” p. 102, “anilofos” p. 241, “etobenzamid (HW-52)” p. 54, “sulcotrione (ICIA-0051)” p. 268, “poast” p. 253, “focus” p. 222, “dimethenamid” p. 48, “sulfosate” p. 236, “2,4-DB” p. 10, “dichlorprop-P” p. 6, “flupoxam” p. 44, “prosulfocarb” p. 84, “quinmerac” p. 233, “metazachlor” p. 64, “flurtamone” p. 265, “bromofenoxim” p. 228, “fomesafen” p. 248, “imazamethabenz-methyl” p. 153, “clodinafop-propargyl” p. 214, “fenoxaprop-P-ethyl” p. 208, “fluazifop-P-butyl” p. 207, “quizalofop-P-ethyl” p. 210, “quizalofop-terfuryl” p. 211, “flumioxazin” p. 43, “flumipropyn” p. 267, “sulfentrazone” p. 261, “thiazopyr” p. 226, “pyrithiobac-sodium” p. 266, “amidosulfuron” p. 151);
“Agricultural Chemicals”, Book II Herbicides, 13^{th} Edition (s. “sulfosulfuron” p. 145, “ethoxysulfuron” p. 149, “carfenstole” p. 284, “pyribenzbxym” p. 279, “diflufenzopyr” p. 90, “ET-751” p. 278, “carfentrazone-ethyl” p. 267, “fluthiacet-methyl” p. 277, “imazapic” p. 160, “butenachlor” p. 54, “tiocarbazil” p. 84, “fluthiamide” p. 62, “isoxaflutole” p. 283, “butroxydim” p. 259,)
“Short Review of Herbicides & PGRs 1991, Hodogaya Chemicals (s. “chlorimuron” p. 92, “chlorsulfuron” p. 92, “flazasulfuron” p. 96, “metsulfuron” S.92, “nicosulfuron” p. 96, “sulfometuron” p. 92, “triasulfuron” p. 94, “furyl-oxyfen” p. 142, “triazofenamid” p. 268, “thenylchlorid (NSK-850)” p. 52, “cumyluron (JC-940)” p. 90, “pendimethalin (AC-92553)” p. 58, “buthidazole” p. 88, “cyprazole” p. 38, “allidochlor” p. 48, “benzoylprop-ethyl” p. 38, “chlorthiamid” p. 150, “diphenamid” p. 34, “flamprop-methyl” p. 40, “fosamin” p. 232, “isoxaben” p. 42, “monalide” p. 32, “naptalam” p. 36, “pronamid” p. 34, “bialaphos” p. 234, “glufosinate-ammonium” p. 234, “glyphosate” p. 232, “amitrol” p. 254, “clomeprop p. 20, “dichlorprop” p. 6, “fenoprop” p. 8, “fluroxypyr” p. 156, “MCPA” p. 4, “MCPB” p. 8, “mecoprop” p. 6, “napropamide” p. 16, “triclopyr” p. 154, “chloramben” p. 28, “dicamba” p. 26, “clomazone” p. 268, “diflufenican” p. 42, “fluorochloridone” p. 266, “fluridone” p. 156, “asulam” p. 112, “barban” p. 100, “butylate” p. 106, “carbetamide” p. 36, “chlorobufam” p. 100, “cycloate” p. 108, “desmedipham” p. 104, “di-allate” p. 106, “EPTC” p. 108, “orbencarb” p. 112, “pebulate” p. 106, “phenisopham” p. 118, “phenmedipham” p. 104, “propham” p. 100, “sulfallate” p. 110, “terbucarb” p. 102, “tri-allate” p. 108, “vernolate” p. 108, “acetochlor” p. 48, “alachlor” p. 46, “diethathyl-ethyl” p. 48, “dimethachlor” p. 50, “metolachlor” p. 46, “propachlor” p. 44, “pymachlor” p. 44, “terbuchlor” p. 48, “xylachlor” p. 52, “alloxydim” p. 260, “clethodim” p. 270, “cloproxydim” p. 268, “tralkoxydim” p. 270, “dalapon” p. 212, “ethofumesate” p. 124, “benefin” p. 54, “butralin” p. 58, “dinitramin” p. 56, “ethalfluralin” p. 60, “fluchloralin” p. 54, “isopropalin” p. 58, “nitralin” p. 58, “oryzalin” p. 60, “prodiamine” p. 62, “profluralin” p. 54, “trifluralin” p. 54, “dinoseb” p. 128, “dinoseb-acetate” p. 128, “dinoterb” p. 128, “DNOC” p. 126, “acifluorfen-sodium” p. 142, “aclonifen” p. 146, “bifenox” p. 140, “chlornitrofen” p. 138, “difenoxuron” p. 76, “fluorodifen” p. 138, “fluoroglycofen-ethyl” p. 146, “lactofen” p. 144, “nitrofen” p. 136, “nitrofluorfen” p. 140, “oxyfluorfen” p. 140, “cyperquat-chloride” p. 158, “difenzoquat-methyl-sulfate” p. 160, “diquat” p. 158, “paraquat-dichloride” p. 158, “benzthiazuron” p. 82, “buturon” p. 66, “chlorbromuron” p. 72, “chloroxuron” p. 76, “chlorotoluron” p. 74, “cycluron” p. 84, “dimefuron” p. 88, “diuron” p. 70, “ethidimuron” p. 86, “fenuron” p. 64, “fluometuron”p. 68, “isoproturon” p. 80, “isouron” p. 88, “karbutilate”p. 76, “linuron” p. 72, “methabenzthiazuron” p. 82, “metoxuron” p. 72, “monolinuron” p. 66, “monuron” p. 64, “neburon” p. 72, “siduron” p. 68, “tebuthiuron” p. 86, “trimeturon” p. 64, “isocarbamid” p. 168, “imazamethapyr” p. 172, “imazapyr” p. 170, “imazaquin” p. 170, “imazethapyr” p. 172, “methazole” p. 162, “oxadiazon” p. 162, “tridiphane” p. 266, “bromoxynil” p. 148, “ioxynil” p. 148, “diclofop-methyl” p. 16, “fenthiapropethyl” p. 20, “fluazifop-butyl” p. 18, “haloxyfop-methyl” p. 18, “isoxapyrifop” p. 22, “propaquizafop” p. 24, “quizalofop-ethyl” p. 20, “chlorfenac” p. 258, “chlorfenprop-methyl” p. 258, “chloridazon” p. 174, “maleic hydrazide” p. 162, “norflurazon” p. 174, “pyridate” p. 176, “clopyralid” p. 154, “picloram” p. 154, “ametryn”p. 198, “atrazine” p. 188, “aziprotryne” p. 206, “cyanazine” p. 192, “cyprazine” p. 192, “desmetryne” p. 200, “dipropetryn” p. 202, “eglinazine-ethyl” p. 208, “hexazinone” p. 208, “procyazine” p. 192, “prometone” p. 196, “prometryn” p. 196, “propazine” p. 188, “secbumeton” p. 196, “simazine” p. 188, “simetryn” p. 196, “terbumeton” p. 204, “terbutryn” p. 198, “terbutylazine” p. 190, “trietazine” p. 188, “ethiozine” p. 210, “metamitron” p. 206, “metribuzin” p. 202, “bromacil” p. 180, “lenacil” p. 180, “terbacil” p. 180, “benazolin” p. 262, “bensulide” p. 228, “benzofluor” p. 266,.“butamifos” p. 228, “DCPA” p. 28, “dichlobenil” p. 148, “endothal” p. 264, “mefluidide” p. 306, “perfluidone” p. 260, “terbuchlor” p. 48);
“Global Herbicide Directory” First Edition, 1994 (s. “oxadiargyl” p. 96);
“European Directory of Agrochemical Products” Volume 2—Herbicides” Fourth Edition, (s. “buminafos” p. 255).
“The Pesticide Manual”, 12th edition (“cloransulamn p. 196, udiclosulam” p. 283, “florasulam” p. 420, “flumetsulam” p. 438, “metosulam” p. 640, “cyclosulfamuron” p. 217);
Moreover, the compound “DEH-112” is disclosed in European Patent Application EP-A 302 203. The compound “tepraloxydim” is described in DE-A 33 36 140; the compound “tritosulfuron” in PCT/EP 96/03996, “cinidon-ethyl” in DE-A 36 03 789, “fencarbazone” in EP 507 171, “foramsulfuron” in U.S. Pat. No. 5,922,646, “carfenstrole (CH-900)” in EP-A 332 133, “picolinafen” in EP 447 004, “penoxsulam” in U.S. Pat. No. 5,858,924 and “fluorbentra-nil” in EP-A 84 893. Other compounds are known from “Brighton Crop Protection Conference—Weeds—1993” (s. “prosulfuron” p. 53, “thidiazimin” p. 29, “AC-322140” p. 41, “KIH-6127” p. 47, “KIH-2023” p. 61, “metobenzuron” p. 67), as well as “Brighton Crop Protection Conference—Weeds—1999” (s. “iodosulfuron” p. 16).

The present invention also extends to herbicidal compositions which comprise a herbicidally active amount of a synergistic herbicidal mixture (comprising components A), B) and, if desired, C) and, if desired, D) as described above), at least one liquid and/or solid carrier and, if desired, at least one surfactant.

The herbicidal compositions and synergistic herbicidal mixtures according to the invention can effect very good control of broad-leaved weeds and grass weeds in crops such as maize, cereals, rice and soya without damaging the crop plants, an effect observed especially even at low rates of application.

Taking into consideration the variety of application method in question, the herbicidal compositions and synergistic herbicidal mixtures according to the invention can additionally be employed in a further number of crop plants for eliminating undesirable plants. Examples of suitable crops are the following:

Allium cepa, Ananas comosus, Arachis hypogaea, Asparagus officinalis, Beta vulgaris ssp. altissima, Beta vulgaris ssp. rapa, Brassica napus var. napus, Brassica napus var. napobrassica, Brassica rapa var. silvestris, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, lpomoea batatas, Juglans regia, Lens culinaris, Linum usitatissimum, Lycopersicon lycopersicum, Malus spp., Manihot esculenta, Medicago sativa, Musa spp., Nicotiana tabacum (N. rustica), Olea europaea, Oryza sativa, Phaseolus lunatus, Phaseolus vulgaris, Picea abies, Pinus spp., Pisum sativum, Prunus avium, Prunus persica, Pyrus communis, Ribes sylvestre, Ricinus communis, Saccharum officinarum, Secale cereale, Solanum tuberosum, Sorghum bicolor (s. vulgare), Theobroma cacao, Trifolium pratense, Triticum aestivum, Triticum durum, Vicia faba, Vitis vinifera und Zea mays.

Moreover, the herbicidal compositions and synergistic herbicidal mixtures according to the invention may also be employed for controlling harmful plants in modified crops. These modified crops are obtained by genetic engineering methods or by breeding, and—as a rule—they are distinguished by particular, advantageous properties, for example by resistance to certain crop protection agents (inter alia ALS tolerant crops, like ALS tolerant corn or ALS tolerant cereals, especially imidazolinone tolerant crops, for example imidazolinone tolerant corn, or HPPD tolerant crops, especially isoxaflutole- mesotrione- or sulcotrione tolerant crops, for example isoxaflutole-, mesotrione- or sulcotrione tolerant cereals), resistance to plant diseases or pathogens causing plant diseases such as particular insects or microorganism such as fungi, bacteria or viruses. Other particular properties relate, for example, to the harvested material in terms of quality, storing properties, composition and specific constitutions.

Preferably herbicidal compositions and synergistic herbicidal mixtures according to the invention are employed for controlling harmful plants in cereals. In a further special embodiment the herbicidal compositions and synergistic herbicidal mixtures according to the invention are employed for controlling harmful plants in modified crops, especially imidazolinone tolerant crops, for example imidazolinone tolerant corn.

The mixtures according to the invention, or the herbicidal compositions comprising them, can be employed, for example, in the form of directly sprayable aqueous solutions, powders, suspensions, also highly-concentrated aqueous, oily or other suspensions or dispersions, emulsions, oil dispersions, pastes, dusts, materials for spreading or granules, by means of spraying, atomizing, dusting, spreading or pouring.

The use forms depend on the intended purposes; in any case, they should guarantee the finest possible distribution of the active ingredients according to the invention.

Suitable inert auxiliaries are mineral oil fractions of medium to high boiling point such as kerosene and diesel oil, furthermore coal tar oils and oils of vegetable or animal origin, aliphatic, cyclic and aromatic hydrocarbons, e.g. paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, such as N-methylpyrrolidone and water.

Aqueous use forms can be prepared from emulsion concentrates, suspensions, pastes, wettable powders or water-dispersible granules by adding water. To prepare emulsions, pastes or oil dispersions, the substances, as such or dissolved in an oil or solvent, can be homogenized in water by means of wetting agent, tackifier, dispersant or emulsifier. However, it is also possible to prepare concentrates composed of active substance, wetting agent, tackifier, dispersant or emulsifier and, if appropriate, solvent or oil, and these concentrates are suitable for dilution with water.

Suitable surfactants are the alkali metal, alkaline earth metal and ammonium salts of aromatic sulfonic acids, e.g. ligno-, phenol-, naphthalene- and dibutyinaphthalenesulfonic acid, and of fatty acids, of alkyl- and alkylaryl sulfonates, of alkyl sulfates, lauryl ether sulfates and fatty alcohol sulfates, and salts of sulfated hexa-, hepta- and octadecanols, and of fatty alcohol glycol ether, condensates of sulfonated naphthalene and its derivatives with formaldehyde, condensates of naphthalene, or of the naphthalene-sulfonic acids, with phenol and formaldehyde, polyoxyethylene octylphenyl ether, ethoxylated isooctyl-, octyl- or nonylphenol, alkylphenyl and tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin-sulfite waste liquors or methylcellulose.

Powders, materials for spreading and dusts can be prepared by mixing or concomitantly grinding the synergistic herbicidal mixture or the individual active ingredients with a solid carrier.

Granules, e.g. coated granules, impregnated granules and homogeneous granules, can be prepared by binding the active ingredients to solid carriers. Solid carriers are mineral earths such as silicas, silica gels, silicates, talc, kaolin, limestone, lime, chalk, bole, loess, clay, dolomite, diatomaceous earth, calcium sulfate, magnesium sulfate, magnesium oxide, ground synthetic material, fertilizers such as ammonium sulfate, ammonium phosphate, ammonium nitrate, ureas and products of vegetable origin such as cereal meal, tree bark meal, wood meal and nutshell meal, cellulose powders or other solid carriers.

The concentrations of the mixtures according to the invention in the ready-to-use products can be varied within wide ranges. In general, the formulations comprise from 0.01 to 95% by weight, preferably 0.5 to 90% by weight, of the mixture according to the invention.

The components A) and B), if desired, C), and, if desired, D) can be formulated jointly, but also separately, and/or applied to the plants, their environment and/or seeds jointly or separately.

In case a compound of group C) is present in the mixture according to the invention it can be used for penetrating the seed of a crop plant (seed dressing), or be incorporated into the seed furrows prior to sowing. The other compounds of the groups A), B) and, if desired, D) are applied then separately from the compound of group C).

It is preferable to apply the active ingredients simultaneously. However, it is also possible to apply them separately.

It is preferable to apply the active ingredients simultaneously. However, it is also possible to apply them separately.

Moreover, it may be advantageous to apply the herbicidal compositions and synergistic herbicidal mixtures according to the invention, jointly or separately, with additional other crop protection agents, for example with pesticides or agents for controlling phytopathogenic fungi or bacteria. Also of interest is the miscibility with mineral salt solutions which are employed for treating nutritional and trace element deficiencies. Non-phytotoxic oils and oil concentrates can also be added.

The mixtures according to the invention and the herbicidal compositions can be applied pre- or post-emergence. If the active ingredients are less well tolerated by certain crop plants, application techniques may be used in which the herbicidal compositions are sprayed, with the aid of the spray apparatus, in such a way that they come into as little contact, if any, with the leaves of the sensitive crop plants while reaching the leaves of undesirable plants which grow underneath, or the bare soil (post-directed, lay-by).

In the case of a post-emergence treatment of the plants, the herbicidal compositions according to the invention are preferably applied by foliar application. Application may be effected, for example, by usual spraying techniques with water as the carrier, using amounts of spray mixture of approx. 100 to 1000 l/ha. The compositions may also be applied by the so-called “low-volume” and “ultra-low-volume” methods, or in the form of so-called granules.

As a rule, the synergistic herbicidal mixtures comprise components A), B), if desired, C) and, if desired D) in such weight ratios that the synergistic effect takes place.

The ratios of component A) and B) in the mixture preferably range from 1:0.001 to 1:500, preferably from 1:0.01 to 1:100, particularly preferably from 1:0.1 to 1:50.

The ratios of components A) and C) in the mixture preferably range from 1:0.002 to 1:800, preferably from 1:0.003 to 1:160, particularly preferably from 1:0.02 to 1:160.

The rate of application of pure synergistic herbicidal mixture, i.e. without formulation auxiliaries, amounts to 0.1 to 5000 g/ha, preferably 2 to 2000 g/ha, in particular 8 to 1500 g/ha, of active substance (a.s.), depending on the intended aim, the season, the target plants and growth stage.

The rate of application of the compound of the formula I is from 0.1 to 100 g/ha, as a rule from 1 to 50 g/ha, preferably from 5 to 30 g/ha, of active substance (a.s.).

The rate of application of component B) is from 0.1 to 2000 g/ha, as a rule from 1 to 1000 g/ha, preferably from 5 to 500 g/ha, of active substance (a.s.).

For example the application rate is for
isoxaflutole from 25 to 200 g/ha,
sulcotrione from 100 to 600 g/ha,
mesotrione from 25 to 300 g/ha,
isoxachlortole from 25 to 200 g/ha,
ketospiradox from 25 to 300 g/ha,
2-{2-chloro-4-(methylsulfonyl)-3-[(2,2,2-trifluoroethoxy)methyl]-benzoyl}-3-hydroxy-2-cyclohexen-1-one from 10 to 300 g/ha,
4-Hydroxy-3-{2-[(2-methoxyethoxy)methyl]-6-(trifluoromethyl)-3-pyridinyl]carbonyl]-bicyclo[3.2.1]oct-3-en-2-one from 25 to 300 g/ha,
4-[2-chloro-3-(4,5-dihydroisoxazol-3-yl)-4-methylsulfonylbenzoyl]-1-methyl-5-hydroxy-1H-pyrazole from 10 to 150 g/ha,
4-[2-methyl-3-(4,5-dihydroisoxazol-3-yl)-4-methylsulfonyl-benzoyl]-1-methyl-5-hydroxy-1H-pyrazole from 10 to 150g/ha, of active substance (a.s.).

The rate of application of the component C) is from 0.1 to 5000 g/ha, as a rule from 0.5 to 2000 g/ha, preferably from 1 to 1000 g/ha, of active substance (a.s.).

For example the application rate is for
dichlormid from 200 to 600 g/ha,
benoxacor from 10 to 200 g/ha
LAB 145138 from 50 to 500 g/ha,
MG 190 from 200 to 1000 g/ha,
furilazole from 10 to 200 g/ha,
naphtalic acid anhydride from 300 to 1000 g/ha,
fenchlorim from 20 to 500 g/ha,
fenchlorazole from 5 to 100 g/ha,
mefenpyr-diethyl from 5 to 100 g/ha,
isoxadifen-ethyl from 1 to 50 g/ha,
cloquintocet-mexyl from 1 to 50 g/ha,
   of active substance (a.s.).

The preferred rate of application of the optional compound of group D) is 0.5 to 4000 g/ha, of active substance (a.s.).

### USE EXAMPLES

The mixtures according to the invention were applied pre- or post-emergence (foliar treatment). The herbicidal compounds of groups A) and B) and, if desired, C) and, if desired, D) were applied in the formulation in which they are present as commercially available product.

The herbicidally active compounds of the groups A), B) and, if desired, C) and, if desired, D) were applied in succession or jointly, in the latter case in some cases as a tank mix and in some cases as a readymix, in the form of emulsions, aqueous solutions or suspensions, the vehicle being water (300 to 400 l/ha). In the case of the field trials, application was effected with the aid of a mobile plot sprayer.

The test period extended over 3 to 8 weeks, and the stands were also observed at later points in time.

Damage by the herbicidal compositions was evaluated with reference to a scale of 0% to 100% in comparison with untreated control plots. 0 means no damage and 100 means complete destruction of the plants.

The following examples will demonstrate the action of the herbicidal compositions which can be used according to the invention, without excluding the possibility of other uses.

In these examples, the value E at which only an additive effect of the individual active ingredients is to be expected was calculated by the method of S. R. Colby (Calculating synergistic and antagonistic responses of herbicide combinations, Weeds 15, 20 pp (1967)).

This was done using the formula

$$E = X + Y - \frac{XY}{100}$$

where
X=Percentage of the herbicidal action of the compound of group A) at an application rate of a;
Y=Percentage of the herbicidal action of the compound of group B) at an application rate of b;
E=expected herbicidal action of the compounds of the groups A)+B) at rates of application a+b (in %).

If the value observed exceeds the value E calculated in accordance with Colby's formula, then synergism is present.

The herbicidal mixtures according to the invention exert a greater herbicidal action than would have been expected according to Colby on the basis of the observed effects of the individual components when used alone.

We claim:

1. A synergistic herbicidal mixture comprising
A) [N-(5,7-Dimethoxy(1,2,4)triazolo[1,5-a]pyrimidin-2-yl)-2-methoxy-4-(trifluoromethyl)]-3-pyridinesulfonamide (I) 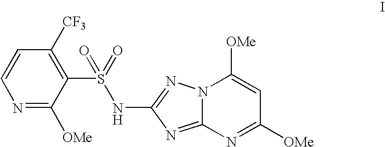
or one of its environmentally compatible salts;
B) at least a synergistically effective amount of a herbicidal compound from the group of the p-hydroxyphenylpyruvat-dioxygenase (HPPD)-inhibitors;
and, optionally,
C) at least one safener selected from the group consisting of dichlormid, benoxacor, LAB 145 138, MG-191, furilazole, cyometrinil, oxabetrinil, fluxofenim, flurazole, naphtalic acid anhydride, fenclorim, fenchlorazole, mefenpyr, isoxadifen, cloquintocet, 1-ethyl-4-hydroxy-3 -(1H-tetrazol-5-yl)-1H-quinolin-2-one, 4-carboxymethyl-chroman-4-carboxylic acid, N-(2-methoxy-benzoyl)-4-(3-methylureido)-benzenesulfonamide, (3-oxo-isothiochroman-4-ylidenemethoxy)-acetic acid methyl ester;
or the environmentally compatible salts, amides, esters and hydrates of each thereof.

2. A synergistic herbicidal mixture as claimed in claim 1, comprising as component B) at least one compound selected from the group consisting of pyrazolynate, pyrazoxyfen, benzofenap, sulcotrione, isoxaflutole, mesotrione, isoxachlortole, ketospiradox, 2-{2-chloro-3-[5-(cyanomethyl)-4,5-dihdroisoxazole-3-yl]-4-ethylsulfonylbenzoyl}-3-hydroxy-2-cyclohexen-1-one, 2-{2-chloro-4-(methylsulfonyl)-3-[(2,2,2-trifluoro-ethoxy)methyl]-benzoyl}-3-hydroxy-2-cyclohexen-1-one, 4-Hydroxy-3-{[2-methyl-6-(trifluoromethyl)-3-pyridinyl]carbonyl}bicyclo-[3.2.1]oct-3-en-2-on, 4-Hydroxy-3-{2- [(2-methoxyethoxy)methyl]-6-(trifluoromethyl)-3-pyridinyl]carbonyl]-bicyclo-[3.2.1]oct-3-en-2-one, 4-Hydroxy-3-[4-(methylsulfonyl)-2-nitrobenzoyl]bicyclo-[3.2.1]oct-3-en-2-one, 4-[2-chloro-3-(3-methyl-isoxazol-5-yl)-4-methylsulfonyl-benzoyl]-1-methyl-5-hydroxy-1H-pyrazole, 4-[2-methyl-3 -(3-methylisoxazol-5-yl)-4-methyl-sulfonylbenzoyl]-1-methyl-5-hydroxy-1H-pyrazole, 4-[2-chloro-3-(4,5-dihydroisoxazol-3-yl)-4-methylsulfonylbenzoyl]- 1 -methyl-5-hydroxy-1H-pyrazole and 4-[2-methyl-3-(4,5-dihydroisoxazol-3-yl)-4-methylsulfonylbenzoyl]-1-methyl-5-hydroxy-1H-pyrazole, or the environmentally compatible salts of each thereof.

3. A synergistic herbicidal mixture as claimed in claim 1, comprising as component B) at least one compound selected from the group consisting of sulcotrione, isoxaflutole, mesotrione, 2-{2-chloro-3-[5-(cyanomethyl)-4,5-dihydroisoxazole-3-yl]-4-ethylsulfonylbenzoyl}-3-hydroxy-2-cyclohexen-1-one, 2-{2-chloro-4-(methyl-sulfonyl)-3-[(2,2,2-trifluoroethoxy)methyl]-benzoyl}-3-hydroxy-2-cyclohexen-1-one, 4-hydroxy-3-{2-[(2-methoxyethoxy)-methyl]-6-(trifluoromethyl)-3-pyridinyl]-carbonyl]bicyclo[3.2.1]oct-3-en-2-one, 4-[2-chloro-3-(4,5-dihydroisoxazol-3-yl)-4-methylsulfonylbenzoyl]-1-methyl-5-hydroxy-1H-pyrazole and 4-[2-methyl-3-(4,5-dihydroisoxazol-3-yl)-4-methylsulfonyl-benzoyl]-1-methyl-5-hydroxy-1H-pyrazole, or the environmentally compatible salts of each thereof.

4. A synergistic herbicidal mixture as claimed in claim 1, comprising as component B) at least one compound selected from the group consisting of mesotrione, 2-{2-chloro-3-[5-(cyanomethyl)-4,5-dihdroisoxazole-3-yl]-4-ethylsulfonylbenzoyl}-3-hydroxy-2-cyclohexen-1-one, 2-{2-chloro-4-(methylsulfonyl)-3-[(2,2,2-trifluoro-ethoxy)methyl]-benzoyl}-3-hydroxy-2-cyclohexen-1-one, 4-hydroxy-3-{2-[(2-meth-oxyethoxy)-methyl]-6-(trifluoromethyl)-3-pyridinyl]carbonyl]bicyclo[3.2.1]oct-3-en-2-one, 4-[2-chloro-3-(4,5-dihydroisoxazol-3-yl)-4-methylsulfonylbenzoyl]-1-methyl-5-hydroxy-1H-pyrazole and 4-[2-methyl-3-(4,5-dihydroisoxazol-3-yl)-4-methylsulfonylbenzoyl]-1-methyl-5-hydroxy-1H-pyrazole, or the environmentally compatible salts of each thereof.

5. A synergistic herbicidal mixture as claimed in claim 1, comprising as component B) 4-[2-chloro-3-(4,5-dihydroisoxazol-3-yl)-4-methylsulfonylbenzoyl]-1-methyl-5-hydroxy-1H-pyrazole, or one of its environmentally compatible salts.

6. A synergistic herbicidal mixture as claimed in claim 1, comprising as component B) 4-[2-methyl-3-(4,5-dihydroisoxazol-3-yl)-4-methylsulfonylbenzoyl]-1-methyl-5-hydroxy-1H-pyrazole, or one of its environmentally compatible salts.

7. A synergistic herbicidal mixture as claimed in claim 1, comprising as component C) at least one compound selected from the group consisting of dichlormid, benoxacor, LAB 145 138, MG-191, furilazole, naphtalic acid anhydride, fenclorim, fenchlorazole, mefenpyr, isoxadifen and cloquintocet, or the environmentally compatible salts, amides, esters and hydrates of each thereof.

8. A synergistic herbicidal mixture as claimed in claim 1, comprising as component C) at least one compound selected from the group consisting of fenclorim, fenchlorazole, mefenpyr, isoxadifen and cloquintocet, or the environmentally compatible salts, amides, esters and hydrates of each thereof.

9. A synergistic herbicidal mixture as claimed in claim 1, comprising as component C) at least one compound selected from the group consisting of mefenpyr, isoxadifen and cloquintocet, or the environmentally compatible salts, amides, esters and hydrates of each thereof.

10. A synergistic herbicidal mixture as claimed in claim 1, comprising as component C) cloquintocet, or one of its environmentally compatible salts, amides, esters and hydrates.

11. A synergistic herbicidal mixture as claimed in claim 1, comprising the compound of formula I, or one of its environmentally salts, and only one compound of group B).

12. A synergistic herbicidal mixture as claimed in claim 1, comprising the compound of formula I, or one of its environmentally salts, and only one compound of group B) and one compound of group C).

13. A synergistic herbicidal mixture as claimed in claim 1 wherein the ratio of the compound of formula I, or one of its environmental salts, and one or more compounds of Group B is from 1:0.001 to 1:500.

14. A synergistic herbicidal mixture as claimed in claim 1 wherein the ratio of the compound of formula I, or one of its environmental salts, and one or more compounds of Group C is from 1:0.002 to 1:800.

15. A herbicidal composition comprising a herbicidally active amount of a synergistic herbicidal mixture as claimed in claim 1, at least one inert liquid and/or solid carrier and optionally, at least one surfactant.

16. A process for the preparation of a herbicidal composition as claimed in claim 15, wherein the compounds of group A), B), and optionally, C), at least one inert liquid and/or solid carrier and optionally, at least one surfactant are mixed.

17. A method for controlling undesired vegetation, which comprises applying a synergistic herbicidal composition as claimed in claim 1, during or after the emergence of undesired plants, wherein the compounds of the groups A), B) and optionally, C) are applied simultaneously.

18. A synergistic herbicidal mixture as claimed in claim 5 comprising as component C) at least one compound selected from the group consisting of dichlormid, benoxacor, LAB 145 138, MG-191, furilazole, naphtalic acid anhydride, fenclorim, fenchlorazole, mefenpyr, isoxadifen and cloquintocet, or the environmentally compatible salts, amides, esters and hydrates of each thereof.

19. A synergistic herbicidal mixture as claimed in claim 6 comprising as component C) at least one compound selected from the group consisting of dichlormid, benoxacor, LAB 145 138, MG-191, furilazole, naphtalic acid anhydride, fenclorim, fenchlorazole, mefenpyr, isoxadifen and cloquintocet, or the environmentally compatible salts, amides, esters and hydrates of each thereof.

20. A synergistic herbicidal mixture as claimed in claim 6 comprising as component C) at least one compound selected from the group consisting of fenclorim, fenchlorazole, mefenpyr, isoxadifen and cloquintocet, or the environmentally compatible salts, amides, esters and hydrates of each thereof.

21. A synergistic herbicidal mixture as claimed in claim 6, comprising as component C) at least a compound selected from the group consisting of mefenpyr, isoxadifen and cloquintocet, or the environmentally compatible salts, amides, esters and hydrates of each thereof.

22. A synergistic herbicidal mixture as claimed in claim 5 comprising as component C) at least a compound selected from the group consisting of fenclorim, fenchlorazole, mefenpyr, isoxadifen and cloquintocet, or the environmentally compatible salts, amides, esters and hydrates of each thereof.

23. A synergistic herbicidal mixture as claimed in claim 5 comprising as component C) at least a compound selected from the group consisting of mefenpyr, isoxadifen and cloquintocet, or the environmentally compatible salts, amides, esters and hydrates of each thereof.

24. A synergistic herbicidal mixture as claimed in claim 1, comprising 4-[2-chloro-3-(4,5-dihydroisoxazol-3-yl)-4-methylsulfonylbenzoyl]-1-methyl-5-hydroxy-1H-pyrazole, or one of its environmentally compatible salts as component B), and cloquintocet, or one of its environmentally compatible salts, amides, esters and hydrates, as component C).

25. A synergistic herbicidal mixture as claimed in claim 1, comprising 4-[2-methyl-3-(4,5-dihydroisoxazol-3-yl)-4-methylsulfonylbenzoyl]-1-methyl-5-hydroxy-1H-pyrazole, or one of its environmentally compatible salts as component B), and cloquintocet, or one of its environmentally compatible salts, amides, esters and hydrates, as component C).

26. A method for controlling undesired vegetation, which comprises applying the compound of formula I and at least one compound of group B), wherein the compound of formula I and the one compound of group B) are applied sequentially in any order.
